(19) United States
(12) Patent Application Publication
(10) Pub. No.: US 2004/0186648 A1
(43) Pub. Date: Sep. 23, 2004

(54) Boundary auto-calibration scheme for proportional poppet valve pressure control

(76) Inventors: Yuhong Zheng, Ann Arbor, MI (US); Danny R. Milot, Ann Arbor, MI (US); Wenwei Song, Ann Arbor, MI (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/803,343

(22) Filed: Mar. 18, 2004

Related U.S. Application Data
(63) Continuation-in-part of application No. PCT/US02/30962, filed on Sep. 26, 2002.

(51) Int. Cl. G06G 7/76; G06F 7/70

(52) U.S. Cl. 701/70; 701/78

(57) ABSTRACT

A method of boundary auto-calibration for proportional poppet valve pressure control estimates the boundary deviation of the valve. A pressure command signal is detected and a pressure command derivative over time is obtained. Which closing boundary should be updated is decided based on the sign of the pressure command derivative. A pressure error is obtained by subtracting an actual wheel brake pressure from its pressure command. Then, a modified pressure error is calculated, and a pressure command signal is evaluated to determine whether a braking maneuver is gentle. Next, the modified pressure error is implemented in the estimation. Finally, a boundary table is updated using the resultant boundary deviation estimate. An alternate embodiment implements a fast boundary auto-calibration scheme including a quasi-closed-loop pressure control system using one cycle of pressure upward sweep and pressure downward sweep to cover the entire operating range of pressures for the valves.

### CROSS REFERENCE TO RELATED APPLICATIONS

This application is a continuation of International Application No. PCT/US02/30962 filed Sep. 26, 2002, the disclosures of which are incorporated herein by reference, and which claimed priority to U.S. patent application Ser. No. 09/965,103 filed Sep. 26, 2001 (issued as U.S. Pat. No. 6,692,088), the disclosures of which are incorporated herein by reference, and which also claimed priority to U.S. patent application Ser. No. 09/919,445 filed Jul. 31, 2001 (issued as U.S. Pat. No. 6,634,722), the disclosures of which are incorporated herein by reference.

### BACKGROUND OF THE INVENTION

This invention relates in general to proportional poppet valve control and, in particular, to an auto-calibration scheme for poppet valves in an electrohydraulic brake system. Poppet valves can be used in electrohydraulic brake systems to control the pressure of brake fluid applied to vehicle wheel brakes.

Traditionally, proportional poppet valves are operated in a manner proportional to the voltage applied to the valve's controlling solenoid. The valves are either closed, opened, or are in some intermediate position. Normally this prevents or allows a fluid to pass from one side of the valve to the other. As it relates to this invention, valves either allow or prevent hydraulic fluid flow in a hydraulic circuit, specifically in a hydraulic circuit in a brake system. An electrohydraulic braking (EHB) system utilizes electronically controlled valves, pumps, or a combination thereof to augment, replace, or control the base braking operation of a vehicle brake system. Base braking, sometimes referred to as foundation braking, is the basic braking called for by the operator of a vehicle. In base braking, the brake pedal operates a master cylinder, causing the master cylinder to send pressurized hydraulic brake fluid to the wheel brakes of a vehicle. Advanced braking systems, such as EHB systems, have been used to improve the performance of vehicle braking systems by augmenting or replacing the base braking function with other braking operations.

One of the first of many advanced braking functions that has been developed for vehicles was an Antilock Braking System (ABS), which typically involves the operation of valves and pumps to selectively release and re-apply brakes during a braking operation. While typical base braking is commanded by the operator, ABS braking controls the vehicle brakes to recover from and limit skidding of a vehicle's wheels due to braking the wheels harder than permitted by the available coefficient of friction of the road surface. Since pumps and valves are electronically controlled to augment the base braking operation, a vehicle equipped with ABS may generally be said to have an EHB system.

Another advanced braking function that may be accomplished by a properly configured EHB system is VSC (Vehicle Stability Control), which is a system for selectively actuating vehicle brakes to improve the stability of a vehicle during vehicle maneuvers. Other braking applications producing a pressure command input to the present invention include DRP (Dynamic Rear Proportioning—a system for controlling the front to rear proportioning of a vehicle braking command), TC (Traction Control—which typically involves selective application of brakes during vehicle acceleration to recover from and limit skidding of a vehicle's wheels due to accelerating the wheels faster than permitted by the available coefficient of friction of the road surface), ACC (Autonomous Cruise Control—a cruise control system that can actuate vehicle brakes to maintain proper vehicle spacing relative to a vehicle in front) and similar functions.

A subset of electrohydraulic braking systems is electronic brake management (EBM). EHB systems can allow braking to be primarily controlled by the vehicle driver with a conventional master cylinder system. Additionally, an electronically controlled portion of the system operates the brakes under certain conditions, i.e. anti-lock, traction control, etc. In Electronic Brake Management systems, primary braking is controlled electronically. In an EBM system, the vehicle driver or a safety system generates an electronic signal, which in turn operates the pumps and valves to achieve a braking pressure within the system. A pedal simulator creates the effect for the driver of applying direct braking pressure while also providing a back-up braking system in case of a failure of the primary system. In the back-up system, the pedal simulator acts as a master cylinder during the failure event and provides the hydraulic pressure that actuates the brakes.

Regardless of the type of electrohydraulic braking system that is used, a system with proportional poppet valves has a control process that controls whether the valves are opened, closed or intermediately positioned. In order for a control system to properly control the poppet valves, it must be configured to account for the forces acting on the valves, the natural characteristics of the valves and be able respond to changes in the valve during braking operations.

Proportional poppet valves used in the above-described systems typically comprise a valve armature, a valve seat, and a spring. If an electric current controls the valve, there generally is a solenoid that acts upon a magnet causing the valve armature to be raised from or seated upon the valve seat. Because a valve can be normally open or normally closed, there are different forces acting upon the valve in its default position. Generally, such forces can be a magnetic force, a spring force, an inlet pressure force, or an outlet pressure force. The inlet and outlet pressure forces will ordinarily vary depending upon the load demanded within the system. In that voltage is proportional to current, it is understood that the use of current controls are to be within the scope of the claims of the present invention.

To balance the forces that are naturally occurring on the valve, so that a particular valve is either normally opened or normally closed, the closing boundary must be determined. A closing boundary also compensates for deadband in the system. Deadband compensation is used to reduce delays in valve response to an applied voltage when the valve is in its normal position. In proportional poppet valve pressure controls, a closing boundary is defined as the minimal (for normally open valves) or maximal (for normally closed valves) voltage required to keep an armature assembly in contact with the seat. Closing boundary data, as used for deadband compensation, gives minimal ramp lags but is dependent on how accurately the closing boundary is set. Several factors make it difficult to accurately set the closing boundary under all operating conditions. First, it is difficult to accurately measure the closing boundary. Second, the actual closing boundary changes in a time-variant manner due to operating pressure, temperature and potentially other naturally occurring phenomena. Lastly, the actual boundary varies from one valve to another because of manufacturing tolerances. Proportional poppet valve pressure control systems are very sensitive to inaccuracies in the closing boundary. This high sensitivity can be justified by the fact that poppet valve systems have a far smaller effective control band at a given pressure than systems with spool valves. Another difference between the two-valve system and the one-valve system is that the two-valve system utilizes an apply valve and a release valve to modulate the brake pressure at each wheel. Therefore, boundary variations in any one of the two valves can affect braking performance at a wheel.

One method that can be used to account for variations in multiple valves at one time is a lump-sum method. However, there is a limitation in using lump-sum estimation of boundary variation. The lump-sum approach generally achieves good pressure tracking performance but the system could converge to equilibrium where one valve is not closed while the other is supposed to be open. The degree of the problem in such a system varies with the amount of boundary variation. Another drawback is that given non-linearities in flow gain at a given pressure, the lump-sum effect of boundary variations in two valves would change rapidly whenever there is a change in the valve state (open and closed). As a result, every time there is a change in the valve state, transients are induced.

To exhibit ideal performance in a system, each valve would have to be trimmed individually to match the closing boundary. This individualized tailoring process is time-consuming and expensive to conduct for a mass-produced system. Therefore, it is important to devise a boundary auto-calibration scheme to produce the system in a cost-effective manner.

U.S. Pat. No. 6,086,167 to Heckmann, et al. describes a method and device for regulating wheel brake pressure. Pressure is regulated by a regulator generating a driving signal quantity for a pressure-influencing valve arrangement on the basis of the active operating point of the valve arrangement. Given a pressure differential across the valve arrangement, the operating point can be determined from a predetermined current-pressure characteristic curve. The characteristic curve essentially defines a point (at or near zero flow) from which up or down hydraulic flow is utilized to regulate wheel brake pressure. The boundary addressed in the present invention is the watershed between hydraulic bulk flow and leakage flow, both of which are utilized for wheel brake pressure control.

U.S. Pat. No. 6,030,055 to Schubert improves upon the quality of the pressure control system described in U.S. Pat. No. 6,086,167 and makes manual determination and adjustment of the characteristic curves unnecessary. Primarily, Schubert's invention is based upon the alternative exemplary embodiment of U.S. Pat. No. 6,086,167, where a regulator based on pressure difference between reference pressure and actual wheel brake pressure outputs a pressure correction quantity to the reference pressure, and the corrected reference pressure in turn is used to find activation current from the current-pressure characteristic curve. Schubert describes a process that automatically equalizes the correlation between the pressure difference at a valve and the activation current. The correction quantity occurring in the course of a regulation operation is held within defined limits by appropriate adaptation of the characteristic curves. The limits of the correction quantity are determined as a function of the actual wheel brake pressure and the dynamic ratio of the reference pressure. The characteristic curve for the apply valve is modified during pressure buildup and the characteristic curve for the release valve is modified during pressure reduction.

An estimation approach that estimates boundary deviation should disregard performance changes due to other factors. A system that does disregard such other factors would be beneficial in achieving consistent and convergent estimation. Therefore, an estimation approach based on a different philosophy than that of the patents listed above would provide a more accurate response to a pressure command signal. Consistent estimation would in turn help generate consistent pressure control performance for different types of pressure commands. Additionally, it would be advantageous to implement a calibration scheme that could estimate the boundary values quickly and accurately, for example, for calibration during the manufacturing process.

### SUMMARY OF THE INVENTION

This invention relates to a method for adapting a closing boundary for a proportional valve comprising implementing an estimator including an integral element to estimate boundary variations of the valve. This entails using the sign of the pressure command derivative over time to determine which one of the two estimators for a wheel should be updated. Next a modified pressure error is calculated in such a way that steady state pressure error, resulting from feedforward term mismatch, control deadzone, and other factors, is subtracted from measured pressure error. Finally, the modified pressure error is used as the input to the estimators and the boundary table is updated using the resultant boundary deviation estimates.

The proposed boundary automatic or self-calibration scheme implements two estimators including an integral element that are used to estimate the boundary variations of two valves at each of several channels. Each channel can represent a wheel brake in a hydraulic circuit. The sign of the pressure command derivative over time is used to determine which estimator should be updated. When the pressure command derivative over time is positive, the apply estimator would be updated and the release estimator left unchanged. When the pressure command derivative over time is negative, the apply estimator is ignored and the release estimator is updated. A modified pressure error is calculated and is then used in the estimation. The steady state pressure error resulting from mismatched feedforward term, control deadzone and other factors are then subtracted from the measured pressure error. The only error that remains after completion of the above-described correction process, is the error due to boundary deviation. The boundary deviation error is then used to update the boundary table. Gain scheduling is used in the estimators to deal with potential asymmetry in mapping from boundary deviation to modified pressure error. To avoid transients and integral wind-up, the estimators are updated during gentle braking maneuvers. Finally, the whole pressure region is partitioned into segments with one state variable associated with each segment. The values of state variables are in turn used in computing control commands at the corresponding segments.

An alternate embodiment of the fast boundary auto-calibration scheme includes a quasi-closed-loop pressure control system. The system can be set up for the calibration test in such a way that the apply valves remain active when there is a rising demanded pressure. Conversely, the release valves remain active when there is a falling demanded pressure. The auto-calibration test is preferably set up so that the test only needs one cycle of pressure upward sweep and pressure downward sweep in order to cover the entire operating range of pressures for the valves. Imaginary control signals are calculated under the assumption that the targeted pressure error is present within the self-calibration test. The actual control signals used with the self-calibration test and the imaginary control signals are then used to calculate the estimated boundaries in such a way that the targeted pressure error would result with estimated boundaries in place.

Another alternate embodiment includes a method for adapting the closing boundary for a proportional poppet valve. The steps of the method include measuring a boundary value for the valve at a first pressure, implementing an estimation model, estimating boundary values for the valve at a plurality of pressures, and storing the boundary values for each of said plurality of pressures in a memory device. It is preferred that the boundary be estimated at a pre-determined pressure value that is between 50 and 120 bar, and then the model be employed to estimate the remaining pressure values between 50 and 120 bar. However, it is preferred that this embodiment be implemented with one of the above-described embodiments in order to calibrate the system.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a simplified schematic view of a vehicle braking system including a portion of the system electronic controls and boundary adaptation controls therefore.

FIG. 2 is a graphical comparison of a constantly increasing P_{cmd} signal with an over-compensated deadband for an apply valve.

FIG. 3 is a schematic diagram of a simplified closed-loop pressure control system that processes an output brake pressure based on the demanded brake pressure in the absence of a boundary deviation.

FIG. 4 is a flow diagram representing the steps of the first embodiment of the present invention.

FIG. 5 is a schematic diagram of a boundary auto-calibration system for a pressure control system according to a second embodiment of the invention.

FIG. 6 is a schematic diagram of an imaginary control law sub-function of the auto-calibration system of FIG. 5.

FIG. 7 is a flow diagram of a storage sub-function of the auto-calibration system of FIG. 5.

FIG. 8 is a flow diagram of a first embodiment of an auto-calibration system for a pressure control system according to the invention.

FIG. 9 is a flow diagram of the second embodiment of an auto-calibration system for a pressure control system according to the invention.

FIG. 10 is a flow diagram of the third embodiment of an auto-calibration system for a pressure control system according to the invention.

### DETAILED DESCRIPTION OF THE PREFERRED EMBODIMENT

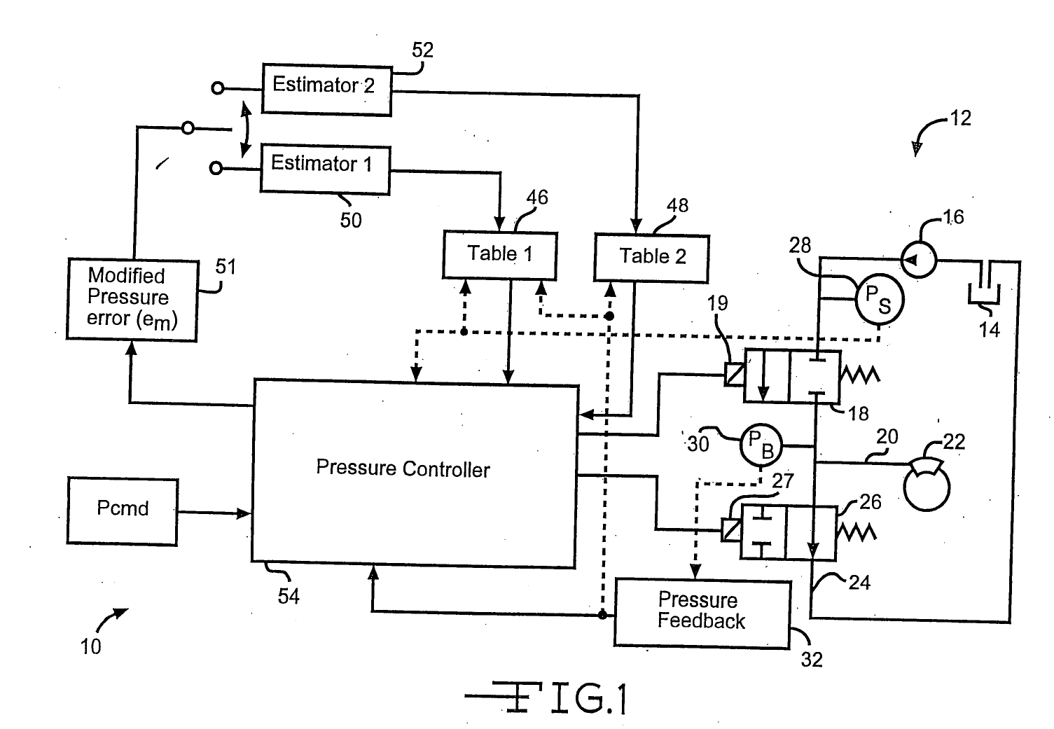

Referring now to the drawings, there is illustrated in FIG. 1 a portion 10 of the electronic circuitry processing braking signals that implements a pressure control algorithm with a greatly simplified schematic representation of a typical EHB braking system 12. The portion 10 of the electronic circuitry also includes the estimators 50, 52 of the present invention. The estimators 50, 52 can also include an integral element.

The simplified EHB system 12 includes a fluid reservoir 14. A pump 16 pumps hydraulic brake fluid from the reservoir 14. The pump 16 (typically complemented by a high-pressure accumulator, not shown) supplies pressurized hydraulic brake fluid to an apply valve 18, which is preferably implemented as a normally closed solenoid operated poppet valve. When the apply valve 18 is opened, pressurized hydraulic brake fluid passes through the apply valve 18, and flows through a conduit 20 to a vehicle wheel brake 22. A fluid conduit 24 is connected to the conduit 20 between the wheel brake 22 and the apply valve 18, and provides a return path for hydraulic brake fluid from the wheel brake 22 to the reservoir 14. A normally open solenoid 27 operated release valve 26 is disposed in the fluid conduit 24 to control the flow of hydraulic brake fluid through the fluid conduit 24.

The flow through the apply valve 18 and release (or dump) valve 26 is controlled by the pressure controller 54 based on an input signal of the pressure commanded by the user of the EHB braking system 12. A pressure command signal, P_{cmd}, can originate from a vehicle driver, or by a signal generated by an EHB system as described above. The signal is then processed in the pressure controller 54 to output a voltage necessary to obtain the demanded flow. Look-up table factors (voltage), represented by Voltage Boundary Table1 46 and Voltage Boundary Table2 48, are implemented in the pressure controller 54 to adjust the voltage applied across the valves (apply valve 18 or release valve 26) based on pre-existing forces on the valve. The look-up tables 46, 48 give the voltages necessary to take the valves 18, 26 from a de-energized state to a just-closed position given the existing pressure differential. The just-closed position is where the valves 18, 26 are closed and the seat force is zero. For the apply valve 18, the pressure differential is established by considering the supply pressure 28 minus the wheel brake pressure 30 (Pₛ-P_{b}). For the release valve 26, the pressure differential is the same as the wheel brake pressure 30 (P_{b}) because the pressure in the fluid reservoir is approximately zero. The de-energized state for the apply valve 18 is normally closed and the de-energized state for the release valve 26 is normally open. Voltage Boundary Table1 46 supplies the voltage values to be used when voltage is applied to the apply valve 18 and Voltage Boundary Table2 48 supplies the values respective to the release valve 26. The voltage values for the voltage boundary tables 46, 48 account for pre-load forces from a spring connected to the valve armature and the pressure differential force across the valve 18, 26. The voltage values for the voltage boundary tables 46, 48 can be determined based on experimentation, the natural characteristics of a particular valve and the operating conditions. Since each valve in actual use will have different natural characteristics due to manufacturing, installation and other factors, the table voltage values will need to be updated based on those natural characteristics.

The table voltage values are updated based on system response to the pressure command signal as described below. The amount the table voltage values are updated is estimated based on the modified error between the pressure command signal and the actual pressure realized by activation of the valve. The amount of the modified pressure error, eₘ, is determined from information within the pressure controller 54. One of the estimators 50, 52 will act to compensate for the modified pressure error. The output of the estimator 50, 52 then updates the table voltage values by increasing or decreasing the table voltage values.

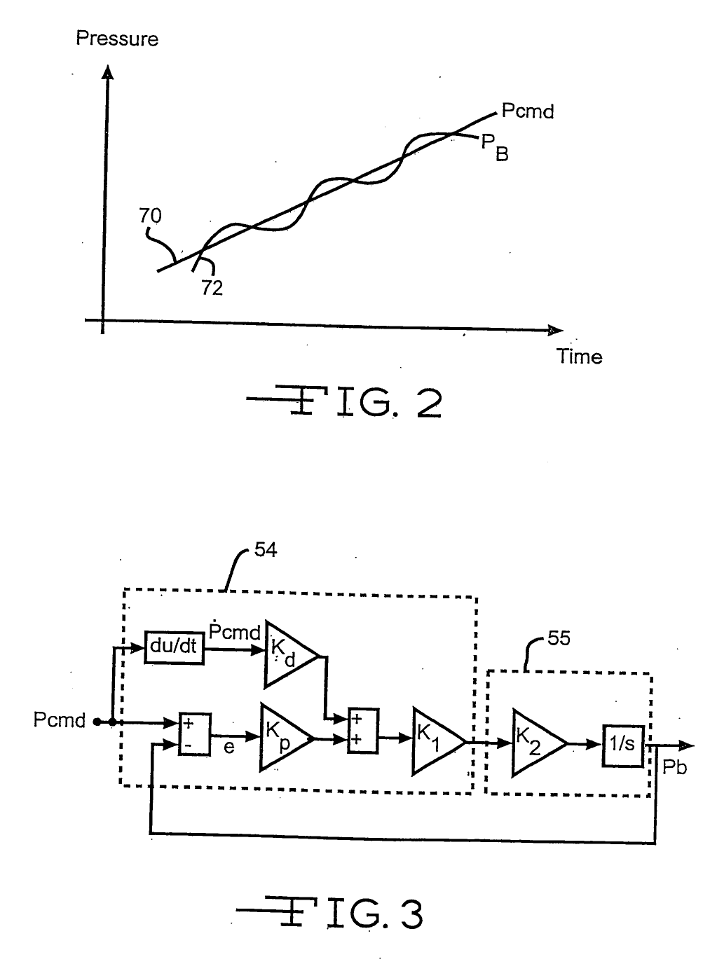

It is preferred that only one estimate should be updated at a time. There are several conditions that can be used to determine whether an estimator should be updated. The first condition is based on the polarity of the brake pressure derivative over time. That is to enable the apply estimator if the brake pressure derivative over time is greater than zero (\dot{P}_{b}>0) and enables the release estimator if the brake pressure derivative over time is less than zero (\dot{P}_{b}<0). However, there are several drawbacks to using this condition to determine whether to update the estimators. First, brake pressure is generally noisy and also prone to disturbances, especially in a closed-loop system. This allows small variations due to noise to cause the estimators to update. Second, if one of the boundary curves over-compensates the deadband, oscillations in the brake pressure due to the aggressive boundary setting would provide false information on the other boundary of the wheel. This can be seen in FIG. 2. In FIG. 2, the curve 70 represents a pressure command signal with a constant rise rate. Curve 72 represents a brake pressure signal with an aggressive or over-compensated response from an apply valve 18. The oscillations above and below curve 70 demonstrate an overly aggressive apply boundary setting. Therefore, while only the apply valve 18 is supposed to be active to accommodate the rising pressure command signal, a release valve 26 would also be active when the braking pressure curve 72 overshoots the pressure command curve 70. This would cause table voltage values for both valves 18, 26 to update when only the apply valve 18 should be considered. Finally, it is hard to distinguish between transients and a steady state with an aggressive boundary curve.

A second condition under which one estimate should be updated is based on whether the corresponding valve 18, 26 is commanded to be active. This results in essentially the same result as the first condition, described above. Oscillations due to one aggressive boundary curve provide false information on the other boundary of the wheel. The curves shown in FIG. 2 again represent this condition.

In the present invention, the polarity of the pressure command derivative over time is used to determine whether to update the estimators 50, 52. That is, to enable the apply estimator 50 if the pressure command derivative over time is greater than zero (\dot{P}_{cmd}>0) and enable the release estimator 52 if the pressure command derivative over time is less than zero (\dot{P}_{cmd}<0), regardless of the actual state of the respective valve 18, 26. This strategy is the most effective because the apply valve 18 is supposed to be active whenever brake pressure buildup is requested (\dot{P}_{cmd}>0) and the release valve 26 is supposed to be active whenever brake pressure reduction is requested (\dot{P}_{cmd}<0). If the rate of change in pressure command is positive, then the apply valve is active so that there can be an increase in braking pressure. This is also demonstrated in FIG. 2. The slope of curve 70 indicates an increasing pressure command signal. The slope of the curve, \dot{P}_{cmd}, is therefore also positive. The opposite is also true. If the rate of change in pressure command is negative, then the release valve 26 is active so that there can be a decrease in braking pressure. Violations of this system would indicate deadband over-compensation for the valve that is supposed to be active. In the case of deadband under-compensation, the result of the system operation would be similar to that under the first condition, as described above. However, in the case of deadband over-compensation, the strategy of the present invention allows correction even while a valve 18, 26 is inactive.

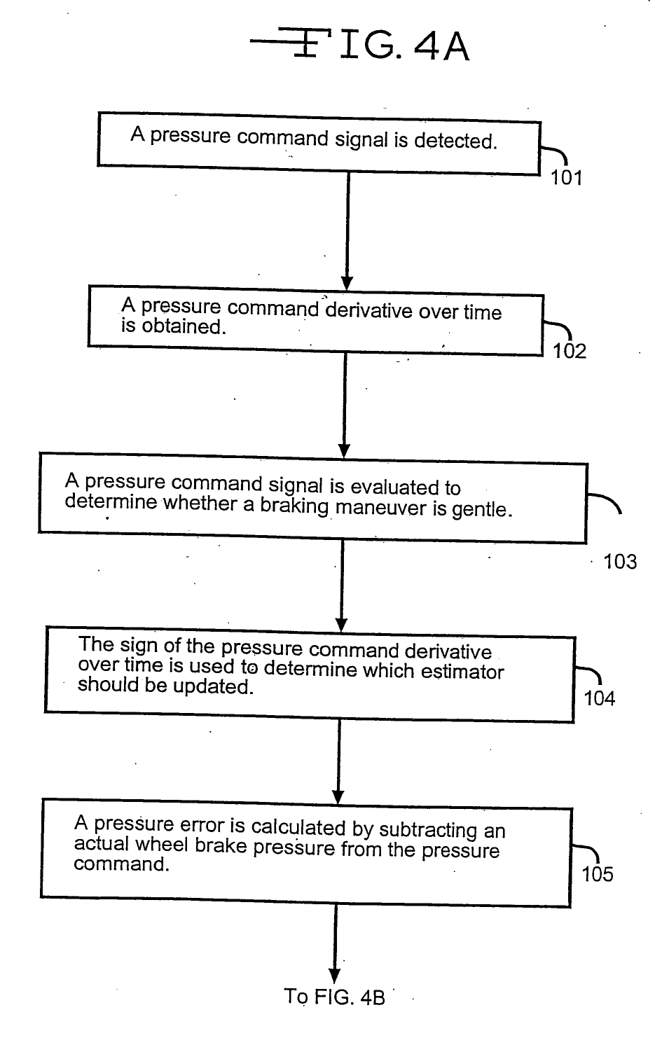

For the purpose of the present invention, an integral element is included in the preferred algorithm used to estimate boundary deviation from the nominal boundary. However, pressure error between the pressure command and wheel brake pressure is not used directly in the estimators, as is the case with the invention disclosed in U.S. Pat. No. 6,030,055 to Schubert. Instead, a modified pressure error is used such that pressure error resulting from other factors, including a mismatched feedforward term and a control deadzone, is excluded. Because integration is part of the respective estimators 50, 52, the boundary estimate will converge to a point where the modified pressure error is zero but pressure error is not zero. The difference between pressure error and modified pressure error is a function of the pressure command derivative over time, control deadzone and any other factors. The use of modified pressure error in the estimator helps achieve a consistent boundary estimate and therefore consistent pressure control performance for different types of pressure commands. FIG. 3 exemplifies a method of calculating modified pressure error. The process is illustrated in a simplified closed-loop pressure control system with perfect boundary match.

In FIG. 3, P_{cmd} and P_{b} represent the pressure commanded by the braking system 12 and the brake pressure actually realized by the braking system 12, respectively. The simplified physical system, with voltage as its input and wheel brake pressure as its output, consists of gain factor K₂ and integral element “1/s”. The gain factor K₂ represents lump-sum physical gain from the voltage to the wheel brake pressure P_{b}, and the integral element “1/s” denotes the dominating dynamic relationship for the simplified system. The simplified controller, with pressure command P_{cmd} and wheel brake pressure P_{b} as inputs and voltage as output, is composed of a proportional feedback control and a derivative feedforward control. The proportional gain for the proportional feedback control, Kₚ, acts on the pressure error e between the pressure command P_{cmd} and the wheel brake pressure P_{b}. The derivative gain for the derivative feedforward control, K_{d}, acts on the pressure command derivative over time. Finally gain factor K₁, which acts on the sum of the proportional feedback control output and the derivative feedforward control output, should be set to K₂⁻¹. When P_{cmd} has a constant ramp rate, the steady state pressure error, eₛₛ, is represented by the following equation:

$${e}_{ss} = \frac{{( {K}_{1} {K}_{2} )}^{- 1} - {K}_{d}}{{K}_{p}} {\dot{P}}_{cmd} \qquad [ I ]$$

In the case where K₁K₂=1, which represents that there is perfect gain match, the modified steady state error can be made equal to zero by subtracting the following steady state pressure error, eₛₛ, from pressure error e:

$${e}_{ss} = ( \frac{1 - {K}_{d}}{{K}_{p}} ) {\dot{P}}_{cmd} \qquad [ II ]$$

Therefore, the modified pressure error eₘ is as follows:

$${e}_{m} = \frac{{Q}_{dem} - {\dot{P}}_{cmd}}{{K}_{p}} \qquad [ III ]$$

In equation III, Q_{dem}=Kₚe+K_{d}\dot{P}_{cmd} and represents the demanded change in the amount of flow in a brake caliper. If control deadzone is defined as both valves 18, 26 being inactive when Q_{dem} ∈ (−switch, +switch), then the modified pressure error, eₘ, is as follows:

$${e}_{m} = \{ \begin{matrix}min \{ \frac{{Q}_{dem} - switch}{{K}_{p}} , \frac{{Q}_{dem} - {\dot{P}}_{cmd}}{{K}_{p}} \} \\ max \{ \frac{{Q}_{dem} + switch}{{K}_{p}} , \frac{{Q}_{dem} - {\dot{P}}_{cmd}}{{K}_{p}} \}\end{matrix} \qquad [ IV ]$$

The equation II represents the modified pressure error, eₛₛ for the apply estimator. The equation III is the modified pressure error, eₘ, for the release estimator. The first term in the min/max function, described above, is used to accommodate the control deadzone, such that integral wind-up would not result. It should be noted that the formula introduced in the example is not meant to limit the way that modified pressure error can be calculated, and the block diagram shown in FIG. 3 is not meant to restrict the scope of closed-loop pressure control strategy. The pressure error calculation depends on the control law used to calculate the error. The error calculation can implement gain factors that are functions of other variables in the system. For example, Kₚ could be a function of feedback pressure instead of being a constant. Alternatively, the error could be calculated without using \dot{P}_{cmd}.

In practice, it is not practical to assume that K₁K₂=1 over the whole pressure range of valve operations. If there is a mismatch in the gain, the mismatch can be viewed as a boundary deviation from the perspective of the estimators 50, 52. Additionally, these perceived boundary variations will be proportional to \dot{P}_{cmd}. To minimize the effect of these perceived boundary variations the estimators 50, 52 are updated only at low absolute values for \dot{P}_{cmd}, |\dot{P}_{cmd}|, (i.e. relatively small negative or positive values for \dot{P}_{cmd} that are obtained during gentle braking maneuvers). By updating the estimators only at low |\dot{P}_{cmd}| values, integration will result in much more accurate values. “Gentle braking” can be considered any braking where the absolute value of the pressure command derivative, \dot{P}_{cmd}, is less than the maximum allowable rate of change for wheel brake pressure, for a given valve in an EHB braking system 12. Gentle braking could also be considered gradual braking where the change in pressure command is low. For example, it could be considered gradual braking when the change in rate of pressure command, \dot{P}_{cmd}, is less than or equal to 100 bar/sec. At values of |\dot{P}_{cmd}| that are less than a pre-specified amount, the estimators 50, 52 would be updated. A pre-specified amount could be any value that is less than the maximum pressure command derivative, \dot{P}_{cmd}, for a given valve. The pre-specified value could be fixed across the entire operating pressure range or can vary with pressure conditions. The pressure conditions that vary include the wheel brake pressure and the pressure differentials across a valve 18 or 26.

An additional reason for updating the estimators only at low |\dot{P}_{cmd}| values is that, due to the physical dimensions of valve openings, there is a limit on the amount of fluid that can flow through an active valve, 18 or 26. As a result, if there is a large absolute value of \dot{P}_{cmd}, the active valve 18 or 26 may not be able to allow flow through the valve 18 or 26 at a rate that matches the demanded flow. As a result, the boundary adjustment will not be as accurate as when the updates take place during a lower flow demand event.

Unlike a spool valve where a bias on one side of the valve goes with the same amount of bias with the opposite polarity on the other side, the poppet valve has numerous combinations. It is demonstrated in FIG. 2 that both positive and negative modified pressure errors could exist with an over-compensated apply deadband, while a under-compensated apply deadband always leads to positive modified pressure error during pressure buildup. Therefore, it is possible to have a positive estimation result for an over-compensated apply deadband, but a positive estimation result would in turn aggravate the apply deadband over-compensation. As a result, there is a need for gain scheduling in the estimators 50, 52 to deal with this type of asymmetry in mapping from boundary deviation to modified pressure error.

Pressure differential related variations can be handled by using a well-given nominal boundary to reduce the amplitude and frequency of the deviations. Normally, deviations from the nominal boundary will vary over the entire pressure differential. In one embodiment, the entire boundary region is partitioned into many segments with one state variable assigned with each segment. The result of the estimation is stored in the state variable associated with the current segment. The values of state variables can be either directly used in computing control commands, or used in linear interpolation to avoid discontinuity between adjacent segments. This is also described in greater detail below.

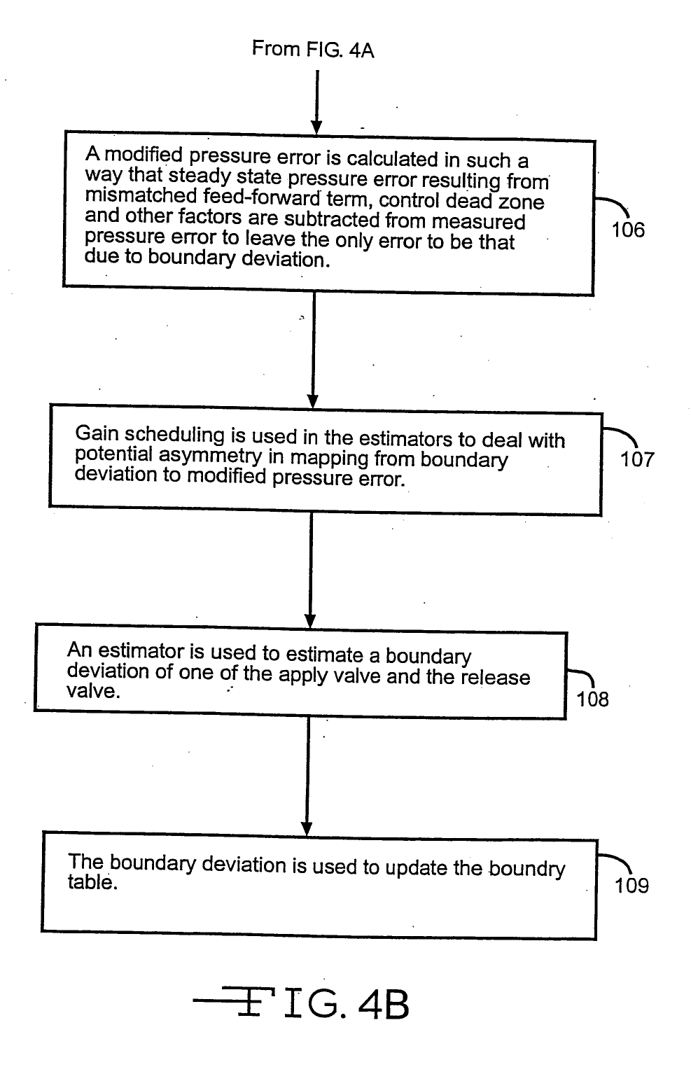

As shown in FIG. 4a and 4b, the proposed boundary auto-calibration scheme is therefore summarized as follows: (1) In a first step 101, a pressure command signal is detected; (2) in a second step 102, a pressure command derivative over time is obtained; (3) in a third step 103 a pressure command derivative over time is preferably evaluated to determine whether a braking maneuver is gentle; (4) in a fourth step 104, the sign of the pressure command derivative over time is used to determine which estimator 50 or 52 should be updated, that is, the apply estimator 50 should be updated and the release estimator 52 should not when the pressure command derivative over time is positive and vice versa; (5) in a fifth step 105, a pressure error is calculated by subtracting an actual wheel brake pressure from the pressure command; (6) in a sixth step 106, a modified pressure error is calculated in such a way that steady state pressure error resulting from mismatched feedforward term, control deadzone and other factors are subtracted from measured pressure error to leave the only error to be that due to boundary deviation; (7) in a seventh step 107, gain scheduling is used in the estimators 50, 52 to deal with potential asymmetry in mapping from boundary deviation to modified pressure error; (8) in an eighth step 108, an estimator 50 or 52 is used to estimate a boundary deviation of one of the apply valve 18 and the release valve 26; and (9) in a ninth step 109, the boundary deviation is used to update the boundary table 46 or 48. Additionally, the whole pressure region can be partitioned into segments with one state variable associated with each segment, and the values of state variables are in turn used directly or indirectly in computing control command at corresponding segments. The above listed steps have been identified as occurring in a specific order. It is understood that these steps can be accomplished in any order without departing from the spirit or scope of the present invention.

The above-described estimation scheme is preferred for use during actual braking maneuvers. However, prior to actual use, EHB systems are preferably calibrated for proper functionality. The calibration process generally is executed after the installation of an EHB system on a vehicle. One typical EHB system arrangement includes four normally closed apply valves and four normally open release valves. During calibration, a set of voltage values associated with the delta pressure across the valve is established for each valve. These values usually are called boundary values or boundaries, as described above. Therefore, eight sets of boundary values (apply and release) will be obtained from the calibration process. The normally closed apply valve is used to apply pressure to the brake when energized and the normally open release valve is used to reduce the pressure in the brake when the energized level is decreased. Thus the corresponding boundary values are also called apply boundary values and release boundary values, or apply boundary and release boundary, respectively.

During calibration, a pre-programmed ramp pressure command, such as zero to 180 bar at the rate of about 36 bar per second, is applied to the EHB system. Of course, any suitable range of pressure commands at any rate suitable for the equipment of the system may be applied. The output pressure, or response, of the system is then measured. The difference between the commanded pressure and the actual pressure realized by the activation of the valve is called the modified pressure error, eₘ, and is described above. The pressure error, eₘ, preferably is minimized based on a closed-loop control algorithm. When the errors associated with different pressures are reduced to a certain acceptable level, the voltage values corresponding to the pressure levels, called boundary values, are recorded to the system. The recordation can be to a flash memory device, such as a flash-ROM chip, or any other suitable memory device.

As stated above, proportional poppet valve pressure control systems are relatively sensitive to inaccuracies in a closing boundary when compared to pressure control systems for spool valves. This high sensitivity can be justified by the fact that a system using poppet valves has a far smaller effective control band at a given pressure than a system that operates with spool valves. However, the actual boundary varies from one valve to another because of manufacturing tolerances. For this reason, depending on the user's preferences and manufacturing objectives, it may be felt to be excessively time-consuming or costly to either measure the closing boundary or to manually trim the valve to match the closing boundary on the vehicle assembly line for the entire operational pressure range of the system. In summary, the first embodiment requires the application of a ΔP across each valve for the whole range of ΔP to be experienced multiple times. It can be stated that the process described in the first embodiment is an iterative process that utilizes multiple integrations in order to determine the optimal boundary value by modifying the previously recorded boundary value by a fraction of the error between commanded pressure and observed pressure. In subsequent iterations, the error ideally approaches zero as the difference between commanded pressure and observed pressure is reduced.

The second embodiment, described below, provides suitable accuracy for many applications and is faster because the pressure is ramped up and down through the entire range of ΔP only once. Thus, in a second embodiment of the present invention, to more quickly auto-calibrate a proportional poppet valve pressure control system may more suitably address any time and efficiency constraints that may be present. It can be stated that the second embodiment utilizes a non-iterative process in that when the boundary value is calculated, based on a single determination of the error between the commanded pressure and observed pressure, the entire error is used as the boundary value.

A limitation of the calibration process, as described in detail above, is that it is generally a time consuming process relative to vehicle assembly line processes. Since the calibration is generally conducted at the vehicle assembly line, the calibration process may create a bottleneck due to the relatively time consuming calibration procedure. To increase the throughput of the assembly line, multiple calibration stations may be required to create parallel flow paths. An additional number of stations would occupy a larger area on the manufacturing facility floor, and therefore, would take up valuable space. Therefore, it would be advantageous to reduce the calibration time so that assembly line speed would not be compromised and so additional stations would not be necessary.

The above-described embodiment provides good results for calibrating the closing boundary for a proportional poppet valve. Particularly, that embodiment is preferable for adapting the closing boundary during ordinary use of the vehicle. That is, the adaptation scheme described above can be used as a per use calibration scheme. This is further preferable due to the amount of time that the described calculations require to be conducted. During normal driving, the relatively long calibration period (e.g. several minutes) that it takes to detect a pressure signal, obtain a pressure command derivative, determining which closing boundary to update, calculating a pressure error and implementing the error to obtain the correct estimation is not a concern to the driver of the vehicle. Additionally, the calibration can be conducted each time the vehicle brakes are used to obtain accurate closing boundaries. This calibration can also be used to update the values determined as the valves and other brake system components wear. Contrarily, in a manufacturing setting, it would be advantageous to implement a boundary self-calibration scheme to allow the system to self-calibrate more quickly and accurately. Therefore, the embodiment described below is preferably active during the manufacturing process, and disabled during normal vehicle use. During normal vehicle use, it is preferred that the above-described embodiment be employed. However, any suitable combination of the systems can be used.

The second embodiment implementing a fast boundary auto-calibration scheme includes a quasi-closed-loop pressure control system. The system can be set up for the calibration test in such a way that the apply valves remain active when there is a rising demanded pressure. Conversely, the release valves can remain active when there is a falling demanded pressure. The auto-calibration test of this embodiment is preferably set up so that the test only needs one cycle of pressure upward sweep and pressure downward sweep in order to cover the entire operating range of pressures for the valves. Imaginary control signals are calculated under the assumption that the targeted pressure error is present within the self-calibration test. The actual control signals used with the self-calibration test and the imaginary control signals are then used to calculate the estimated boundaries in such a way that the targeted pressure error would result with estimated boundaries in place.

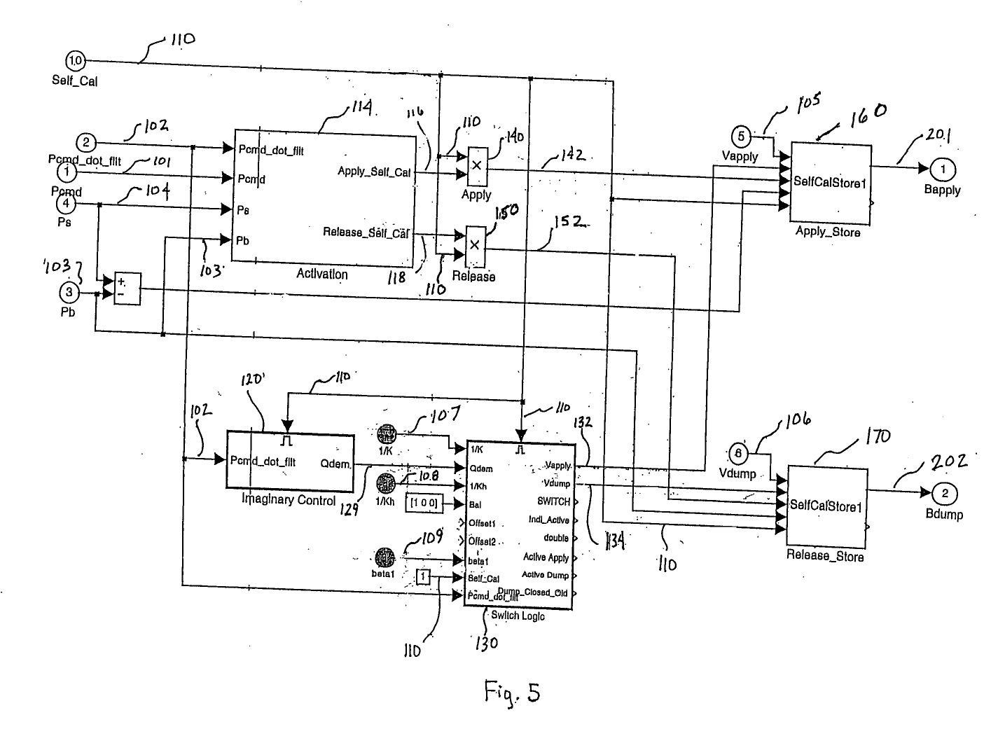

Illustrated in FIG. 5 is a detailed schematic of the boundary auto-calibration scheme. The inputs to the boundary self-calibration scheme are filtered pressure demand derivative, P_{cmd-dot-filt} 102; demanded pressure, P_{cmd} 101; estimated wheel pressure, P_{b} 103; measured supply pressure, Pₛ 104; gain factors 1/K 107 and 1/Kₕ 108, beta1 109, an auto-calibration flag, Self-Cal 110, and outputs from a switch logic function of the EHB system, V_{apply} and V_{dump}. The outputs of the function are closing boundary adjustment values, B_{apply} for the apply valve and B_{dump} for the release valve. The various sub-functions illustrated in FIG. 5 are explained in greater detail below.

In order for this quasi-closed-loop pressure control system to be set up for the auto-calibration in such a way that the apply valves would always be active with rising demanded pressure and the release valves always being active with a falling demanded pressure, an offset value of the demanded flow, Q_{dem} is used in the test system. The offset is established to guarantee that there is at least a specified amount of difference in pressure error between when the modified pressure error is zero and when the Q_{dem} is equal to zero. By setting the offset to infinity, the modified error, eₘ, will never reach the offset and therefore the valve will always remain active with a rising or falling demanded pressure, such as with the apply valve or release valve, respectively.

The self-calibration test is preferably set up so that the test only needs one cycle of pressure sweep to cover the entire operating range of pressures for the valves. To do this, the one cycle of pressure command, P_{cmd}, should take the form of one pressure increase ramp and one pressure decrease ramp with the pressure decrease ramp having different rates of pressure decrease at different regions of the pressure range. The boundary auto calibration function contains sub-functions that are adapted to assist in the operation of the complete closed-loop system. The sub-functions are activation, imaginary control, switch logic, and storage (for both apply and release). The activation sub-function provides conditions applicable to both the apply and release valves and determines whether to enable the ensuing boundary update routines. At least one condition provided by the activation sub-function is the determination of hydraulic saturation conditions. Hydraulic saturation conditions are the maximum apply or release rates for the valve as configured in the system. The maximum hydraulic capability reflected by the orifice size is a non-linear function of pressure differential across the valve and brake pressure. The maximum hydraulic capability is the best rate the pressure can be applied and can vary with the brake line length, brake load, the maximum accumulator pressure, as well as other physical characteristics of the brake system. If there is a particular error entering the system, then after several iterations the error will sum to infinity. Therefore, to prevent integrator wind-up from occurring, the operating program can limit the maximum error that can be reached. For example, to prevent integrator wind-up, the following hydraulic saturation conditions could be satisfied prior to any further calculations on the boundary value updates being conducted:

P_{cmd-filt}≦Pₛ−5 bar [V]

$$\{ \begin{matrix}{P}_{cmd \text{-} filt} \\ {P}_{b} \geq 5\end{matrix} \geq \{ \begin{matrix}2.5 bar \\ 10 bar\end{matrix}$$

If P_{cmd}>0 for at 0.25 seconds, otherwise

when P_{cmd-dot-filt}<0

and P_{cmd-dot-filt}>Maximum Dump Rate which is a function of P_{cmd-filt}

when P_{cmd-filt}≦10 bar [VI]

P_{cmd-filt} is the commanded pressure after the command signal is processed through a first order low pass filter essentially to reduce the noise in the brake system. P_{cmd-dot-filt} is the rate of change of P_{cmd-filt}, which is then filtered again through another first order low pass filter to further reduce noise. The result of the above condition equations are used to determine whether a True or False condition is satisfied. The polarity of P_{cmd-filt} determines whether the conditions are met. If the polarity is positive, then the Apply valve signal, Apply-Self-Cal is activated and the signal moves on line 116 of FIG. 5. If the polarity is negative, then Release-Self-Cal is activated and the signal moves on line 118. If there is no polarity, or the value is zero, then neither is activated because neither valve needs to be updated.

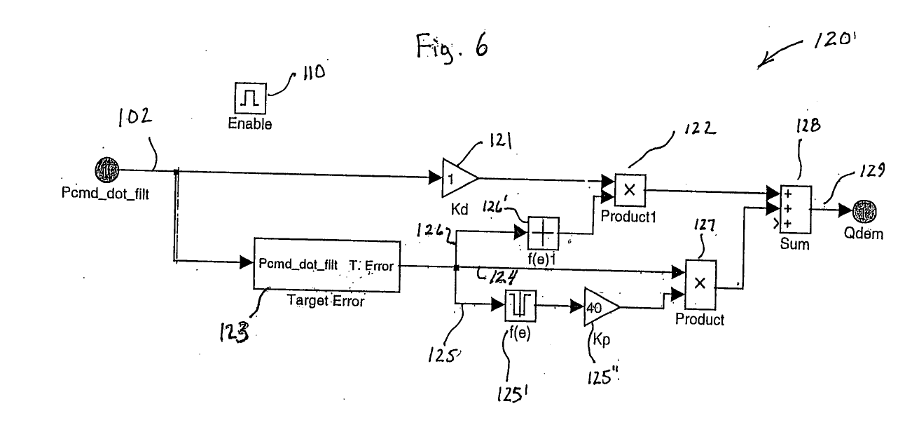

The imaginary control sub-function is based on a “target error”, which is the desired pressure error for the auto calibration function to achieve. The “target error” can be determined using the following equation:

$$Target Error = ( \frac{1 - {K}_{d}}{{K}_{p}} + Delay ) {P}_{cmd \text{-} dot \text{-} filt} \qquad [ VII ]$$

where K_{d} and Kₚ are the same gain factors described above in equations I-IV. Delay is a time delay between the command pressure signal and the detection of a response to that signal. If the signal is processed quickly, then the calibration process is not implemented. If the signal takes a long time to process, then the calibration continues as shown in FIG. 6 at lines 124, 125 and 126.

Illustrated in FIG. 6 is a schematic diagram for the imaginary control sub-function 120. The imaginary control sub-function 120 is used to provide an imaginary demanded flow, Q_{dem}, to the calibration scheme. The imaginary control function is in essence a function that defines an idealized demanded flow, Q_{dem}, for the calibration scheme. If it is determined that the imaginary control sub-function 120 is to be enabled, then the imaginary control sub-function activates as a part of the self-calibration scheme through an input on the line 110. The input into the imaginary control sub-function 120 on the line 110 is the pressure command derivative, P_{cmd-dot-filt}. The target error, calculated in equation VII, is combined with the P_{cmd-dot-filt} in block 123 to resolve them into factors and split into two tracks. Factors are any of the numbers or symbols in mathematics that when multiplied together form a product quantity by which a given quantity is multiplied or divided in order to indicate a difference in measurement (costs increased by a˜of 10). A first track takes P_{cmd-dot-filt} and modifies it by gain factor K_{d} in a step 121. The output of this track goes to a factor box 122. On a second track, P_{cmd-dot-filt} is factored with the Target Error in a step 123. The output of the Target Error factor at step 123 feeds into three Target Error tracks 124, 125, and 126. The Target Error output track 124 feeds straight into a multiplication box 127. The second Target Error track 125 takes the output of the Target Error step 123 and processes it through a function box 125′, which modifies the signal passing therethrough as a function. The output of the function box 125′ is modified by gain factor Kₚ as indicated at 125″. After modification by the gain factor Kₚ, the signal is finally multiplied with the signal of the first Target Error track 124 in the factor box 127. The function box 125′ processes the Target Error through a function that acts as a gain schedule. The function preferably allows a non-linear gain based on the input value to adjust the Target Error. However, it should be understood that a linear gain could also be used. The third Target Error track 126 flows from the Target Error factor 123 through a function box 126′ and into the factor box 122. The function box 126′ also processes the Target Error through a function. The function 126′ has the same effect as the function 125′ and serves the same general purpose, however it can be based on different values. The signal of the first track out of step 121 and the signal of the third Target Error track out of the function box 126′ are factored together in factor box 122 and flow to a final adder box 128. In the final adder box 128, the output of the second and third Target Error tracks multiplication in the multiplication box 127 are added to the output of the factor box 122. The sum is output on the line 129 and is the demanded flow, Q_{dem}, for the given P_{cmd-dot-filt}. Referring again to FIG. 5, for the switch logic sub-function 130 it is preferred that the input demanded flow, Q_{dem}, comes from the imaginary control function 120.

Deviations from the nominal boundary can occur anywhere over the pressure differential range experienced by the valve under control. A well given nominal boundary and a robust hardware design will reduce the amplitude and frequency of the deviations. In a preferred embodiment, in which the valve will experience differential pressures in the range of 0-180 bar, the pressure region is divided into 17 segments (10 bar each between 5 bar and 175 bar) with one state variable, Self-Cal-Data[], associated with each segment (i.e., Self-Cal-Data[1], Self-Cal-Data[2], etc.). The difference between actual voltage command and imaginary voltage command is calculated, and then the averaged difference over a segment is stored in the state variable, Self-Cal-Data[]. The averaged difference can be determined anytime a difference is detected. The difference between actual command voltage and the imaginary voltage command (for a given 10 bar pressure region) is added to any previously obtained voltage difference (for that same region). The sum is then divided by the number total number of cycles where there has been a difference. This results in an averaged difference over a segment. The values of the state variables are not directly used in computing control command. However, linear interpolation at the mid-point of a segment should be equal to Self-Cal-Data[].

It should be noted that while the preferred embodiment is described as having 17 segments of 10 bar differential pressure each, any suitable number of segments of any suitable pressure ranges may be used depending on the particular design objectives. It is contemplated that in some embodiments some segments may be a different span than others if experience with a certain valve justifies this. For example, if a particular valve design has a greater frequency of deviations from a nominal boundary when ΔPs are high, the segments in this range may be more numerous and cover a smaller pressure range than the segments at low ΔPs where the frequency of deviations is not as great.

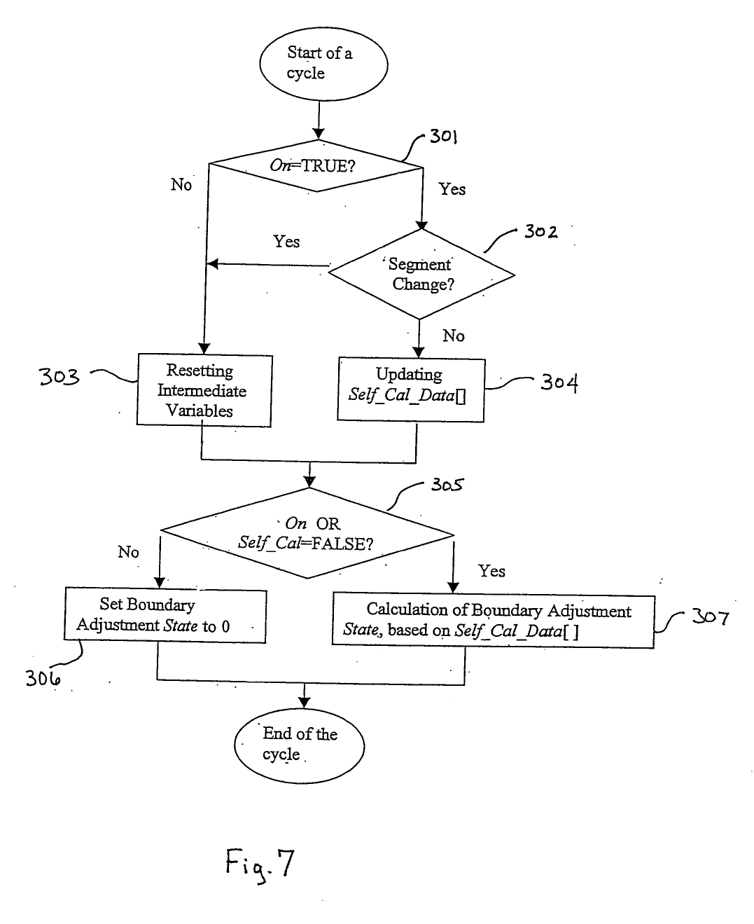

Illustrated in FIG. 7 is the flow diagram of the storage sub-function, as is also illustrated in FIG. 5 at 160 and 170 for the apply and release valves, respectively. It should be understood that the flow diagram applies to either the apply valve or release valve depending on which valve is being calibrated. The sub-function essentially determines whether to store the calculated boundary value. For the purpose of simplicity of explanation, FIG. 7 is being described as it applies to the apply valve, however, the same process can be applied to the release valve. At the start of a cycle, in step 301, it is determined whether the Apply_Self_Cal is activated. If so, the signal flow is as shown in FIG. 5 at line 142. The next step 302 is used to determine whether the EHB system is operating in a different segment of the 17 pressure segments than the segment that was previously stored during a previous calculation cycle. If so, then the intermediate variables are reset in a step 303. This is also what occurs if the system is not “on” in the initial determination in a step 301. If there is no segment change, the Self-Cal-Data[] is updated in step 304 based on the input values to the activation sub-function. From this point, whether the signal comes from step 303 or 304, the process determines again in step 305 that which was checked in step 301, whether the Apply_Self_Cal is activated or the Self_Cal from line 110, is not activated. That is, the storage sub-function determines whether the information dictates that the previously stored values need to be updated. If not, then the adjustment is set to zero in a step 306. If an update is required, the boundary adjustment is determined based on the Self-Cal-Data[] value in a step 307, as is seen in block 160 in FIG. 5. However, for the release valve, the Release_Self_Cal is on line 152, and the update of the boundary value is in block 170.

The calculation of the boundary adjustment state in the step 307, which is the interpolation of Self-Cal-Data[], is done as follows:

If ΔP (Pressure Differential across the valve)<10 bar,

then State=Self-Cal-Data[0] otherwise,

if ΔP≧170 bar,

then State=Self-Cal-Data[16]. However, if the P is in the range from less than 170 bar down to and including 10 bar, then

State=Self-Cal-Data[i−1]+(Self-Cal-Data[i]-Self-Cal-Data[i−1])*(ΔP/10−i)

where i≦ΔP/10<i+1

Once the state is determined, the self-calibration system has the information required to determine whether to update the stored boundary values.

The above-described self-calibration cycle has four operating phases. In the initial operating phase, the EHB system is initially inactive. However, it should be understood that the system could be at any operating point during this initial operating phase. The waiting phase occurs immediately after setting the Self-Calibration code. In the second phase, the waiting phase, the pressure command, P_{cmd}, is set to about 5 bar to try and fill the brake calipers 22. Additionally, the pressure in the accumulator (not shown) is controlled to be between about 180 bar and about 185 bar. In the third phase, the auto-calibration phase, the accumulator pressure is preferably held above 180 bar and the pressure command is set at 5 bar for a per-determined short period of time. After that interval, the pressure command, P_{cmd}, starts to ramp up at about 40 bar per second from 5 bar. During this operation, it is preferred that the currents for the release valve are kept at the highest levels (as explained above with the offset to guarantee a specified amount of difference in pressure error). Two pump motor control parameters (typically, on and off) are set so that the pump maintains pressure from about 180 (on) to 185 (off) bar, and from about 140 (on) to 145 (off) bar, respectively. After a second pre-determined amount of time of ramping up, the pump motor can activate to allow the accumulator pressure to “coast” down when the pressure command rises. Once the pressure command, P_{cmd}, meets the accumulator pressure at a pressure level between 140 bar to 180 bar (generally around 160 bar), the pressure command, P_{cmd}, starts to ramp down at about 40 bar per second. At 40 bar, the rate of the downward ramp preferably drops to 20 bar per second. During the ramp down, currents for the apply valves are set to zero. In the fourth phase of operation, the normal operating phase, the auto-calibration process is completed. At this point, the pressure command preferably has ramped down to about 5 bar. Then, the auto-calibrated EHB system would return to normal operation. Normal operation encompasses maintaining the accumulator pressure between about 140 bar and 180 bar. As the P_{cmd} is changing during the ramp up and ramp down cycle, the above-described calibration mechanisms are effected to determine the boundary values at the varying P_{cmd} values. This establishes the boundary table values for use with the apply and release valves, as was described above. It should be understood that as a preferred embodiment, the fast self-calibration scheme described above is used during installation at a manufacturing facility. Therefore, the self-calibration cycle with the four phases is really an initial calibration process and the normal operation phase does not generally include typical operation of the EHB system, such as with daily use. However, if the above-described embodiment is used as a daily-use calibration system, then the four phase calibration can be done at start-up with the normal operation phase continuing during the operation of the vehicle.

This self-calibration model can be used on a per use basis with the boundary values being stored in a temporary or a non-erasable memory device (one-time use) during operation of the vehicle. For example, at vehicle startup the calibration process model can be activated and the boundary values being determined based on initial values that are pre-programmed in the system. The values can then be updated during operation of the vehicle.

In a third embodiment of the invention, the time required for auto-calibration of the EHB pressure control system is shorter than the time required for either the first or second embodiments described above. As will be described in detail below, this will be accomplished by limiting the ranges of ΔPs to be applied across the system apply and release valves. That is, instead of cycling through the entire range of ΔPs across the apply valves and release valves several times (at various different brake pressures) as in the first embodiment, or cycling through the entire range of ΔPs across the apply and dump valves once as in the second embodiment, and testing and updating the boundary table values based on these entire range of values, it has been determined that in some applications it may be adequate to only test once at a few specific values of ΔP across the valves. More specifically, in calibrating an EHB system for a four-wheel vehicle, the initial boundary values for the apply valve and release valve for each of the four brakes (left front, right front, left rear and right rear) are determined by testing or experimentation on prototype vehicles. The rate of change for boundary values at given pressure levels could be determined at a given interval of ΔP indicating a rate of change, Vᵣ, of the boundary values. It has been found that Vᵣ is relatively small between about 50 bar and about 120 bar, compared to the rate of change of boundary values, Vᵣ between 0 bar to about 50 bar, and compared to the rate of change of boundary values, Vᵣ between about 120 bar to about 170 bar. Due to the relatively small rate of change in boundary values, Vᵣ, in the range of about 50 bar to 120 bar, at increments of 20 bar, the apply boundary model and release boundary models can be obtained through regression analysis on the sixty sets of boundaries between 50 bar and 120 bar. This analysis shows that there is a relatively small rate of change, Vᵣ between 50 bar and 120 bar. Therefore, the boundary values among different brakes closely parallel each other between 50 bar and 120 bar. This parallelism applies regardless of whether apply boundary values or release boundary values are being determined. Further, this parallelism shows that calibration can be conducted using only one set of measured values between about 50 bar and 120 bar.

Therefore, an apply boundary model and release boundary model can be implemented to estimate the boundary values between about 50 bar and 120 bar. For the estimated boundary values, an estimation model can be simplified using the following equations:

A_{b}=A+A_{b1}*β−A_{b2}*β²+A_{b3}*β³ [VIII]

and D_{b}=B+D_{b1}*β−D_{b2}β²+D_{b3}*β³ [IX]

Where A_{b} and D_{b} are the modeled apply boundary and release boundary values, respectively. A_{b} can be the upper limit of the low valve range, and D_{b} can be the lower limit of the upper valve range. A and B are constants determined by testing the installed system. The pressure value, β, at which the boundary value is to be estimated is measured in bar of pressure. Preferably, the pressure value, β, is estimated between 50 and 170 bar. A_{b1}, A_{b2} and A_{b3} are constants that can be estimated or determined based on values obtained by testing the system and the estimation model being used. D_{b1}, D_{b2} and D_{b3} are preferably similarly determined. It should be understood that the estimated values could be determined by the equation described above, or any suitable statistical interpolation or extrapolation method. For example, A_{b} could be written as a function of the pressure value, β.

A_{b}=F_{apply}(β)

Similarly, for D_{b}, the function could be written as:

D_{b}=Fᵣₑₗₑₐₛₑ(β)

where in either function, the function could be linear, exponential or otherwise, as best suited for the EHB system. Additionally, the estimation can be based on initial pressure values outside the data range of about 50 to 120 bar, and in fact, the estimation can be based on values throughout the pressure range including 0 bar to at least 185 bar.

To apply the estimation model, an initial set of apply or release boundary values are collected from the EHB system. This can be done, for example, by actually testing the system at an initial pressure level. Alternatively, either of the above-described embodiments can be used in conjunction with this embodiment to obtain pressure values. Once the A_{b} or D_{b} value is known from actual tests or implementation of one of the other methods of estimation described above (for example, by determining the pressure error, eₘ, and calculating an initial boundary value by using the equations I-IV) (or indeed, determined by any suitable method of estimation of the valves for A_{b} or D_{b}) then equations VIII and IX can be used to determine the remaining boundary values at other pressure levels. In one typical EHB system it was found that for a four wheel passenger vehicle the pressure levels could be estimated between about 50 bar and 120 bar, but the method is not limited to that pressure range. Additionally, the method of this embodiment can be used with any method of determining boundary values at upper and lower bounds to interpolate or extrapolate the intermediate values. Alternatively, if an upper or lower boundary value have been determined by any suitable method, the method of this embodiment can be used to determine boundary values above or below the upper or lower boundary value.

Typically, a ramp command is used in the calibration process with the ramp being about 36 bar per second from 0 bar to about 180 bar. Of course, any suitable ramp rate through any suitable pressure range could be used in the calibration process. Since the boundary values between about 50 bar and 120 bar are to be estimated based on measured values, the ramp command for the calibration using the above-described embodiment can be 36 bar per second from 0 bar to about 50 bar and from about 120 bar to about 180 bar. This results in a substantial reduction in the amount of time the calibration process takes since the pressure range of about 50 bar to 120 bar is eliminated from being directly measured. As a result, the calibration process is faster and can therefore be used in the vehicle manufacture process without creating a production line bottleneck. It should be understood that the model described herein can also be used in other situations, such as during vehicle startup or as the brakes are used during vehicle operations.

The embodiments described above have been depicted as using voltage controls. Since voltage is proportional to current, it is understood that the use of current controls is also within the scope of the claims of the present invention.

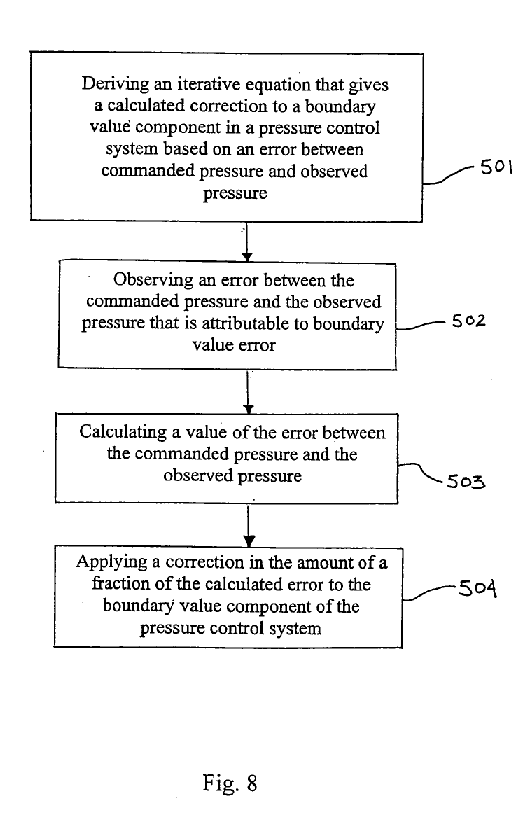

As shown in FIG. 8, the first embodiment of the invention can be summarized as follows: (1) In a first step 501, deriving an iterative equation that gives a calculated correction to a boundary value component in a pressure control system based on an error between commanded pressure and observed pressure; (2) in a second step 502, observing an error between the commanded pressure and the observed pressure that is attributable to boundary value error; (3) in a third step 503, calculating a value of the error between the commanded pressure and the observed pressure; and (4) in a fourth step 504, applying a correction in the amount of a fraction of the calculated error to the boundary value component of the pressure control system.

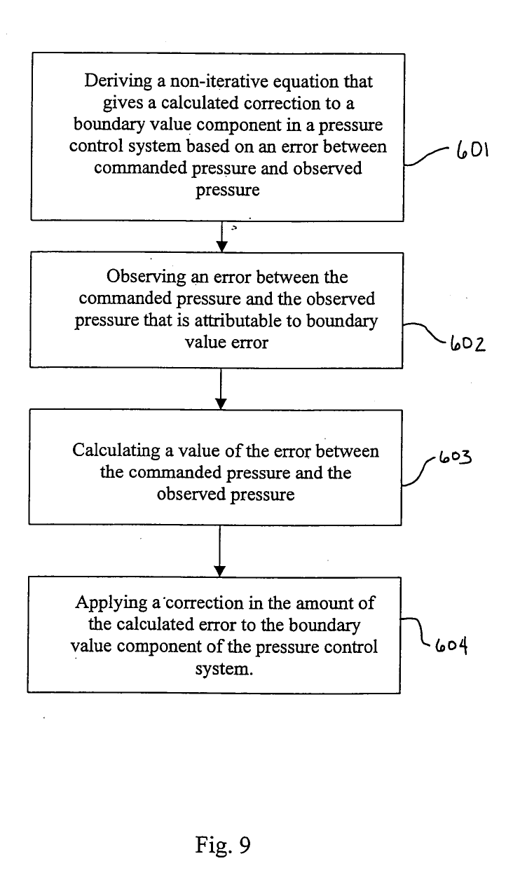

As shown in FIG. 9, the second embodiment of the invention can be summarized as follows: (1) In a first step 601, deriving a non-iterative equation that gives a calculated correction to a boundary value component in a pressure control system based on an error between commanded pressure and observed pressure; (2) in a second step 602, observing an error between the commanded pressure and the observed pressure that is attributable to boundary value error; (3) in a third step 603, calculating a value of the error between the commanded pressure and the observed pressure; and (4) in a fourth step 604, applying a correction in the amount of the calculated error to the boundary value component of the pressure control system.

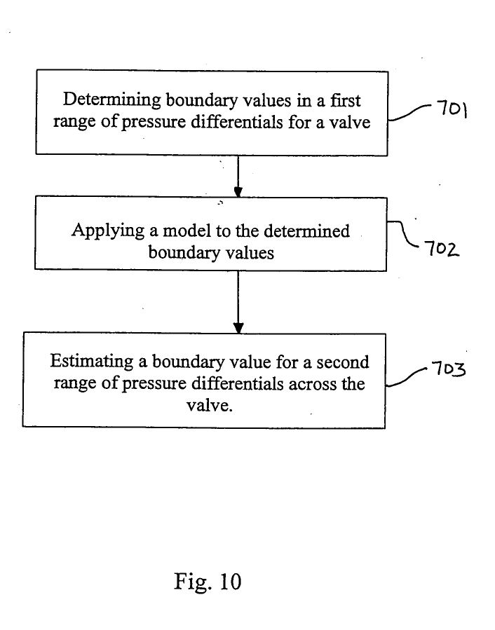

As shown in FIG. 10, the third embodiment of the invention can be summarized as follows: (1) In a first step 701, determining boundary values in a first range of pressure differentials for a valve; (2) in a second step 702, applying a model to the determined boundary values; and (3) in a third step 703, estimating a boundary value for a second range of pressure differentials across the valve.

The principle and mode of operation of this invention have been explained and illustrated in its preferred embodiment. However, it must be understood that this invention may be practiced otherwise than as specifically explained and illustrated without departing from its spirit or scope. For instance, it can be applied with minor or no modifications to estimate the characteristic curves described in U.S. Pat. No. 6,086,167 to Heckmann, et al.

What is claimed is:

1. A non-iterative boundary value correction method comprising the steps of:
a) deriving a non-iterative equation that gives a calculated correction to a boundary value component in a pressure control system based on an error between commanded pressure and observed pressure;
b) observing an error between the commanded pressure and the observed pressure that is attributable to boundary value error;
c) calculating a value of the error between the commanded pressure and the observed pressure; and
d) applying a correction in the amount of the calculated error to the boundary value component of the pressure control system.

2. The method defined in claim 1 wherein the boundary value component is calculated based on a single determination of the error between the commanded pressure and the observed pressure.

3. The method defined in claim 1 wherein the boundary value correction method is implemented each time the pressure control system using the boundary value correction method is operated.

4. The method defined in claim 1 wherein the error between the commanded pressure and the observed pressure is determined for an entire operating range of pressures of the pressure control system.

5. The method defined in claim 4 wherein the boundary value errors for the range of pressures is determined by at least one of a pressure upward sweep and a pressure downward sweep through the range of pressures.

6. The method defined in claim 4 wherein the boundary value errors for the range of pressures is determined by both of a pressure upward sweep and a pressure downward sweep through the range of pressures.

7. The method defined in claim 6 wherein the pressure downward sweep has different rates of pressure decrease at different regions in the range of pressures.

8. A boundary value correction method comprising the steps of:
a) determining boundary values in a first range of pressure differentials for a valve;
b) applying a model to the determined boundary values; and
c) estimating a boundary value for a second range of pressure differentials across the valve.

9. The method defined in claim 8 wherein the first range of pressure differentials are from about 0 bar to about 50 bar.

10. The method defined in claim 9 wherein the second range of pressure differentials are from about 50 bar to about 120 bar.

11. The method defined in claim 8 wherein the first range of pressure differentials are from about 120 bar to about 180 bar.

12. The method defined in claim 11 wherein the second range of pressure differentials are from about 50 bar to about 120 bar.

13. The method defined in claim 12 wherein the model is an estimation model using at least one valve constant and a pressure value at which the boundary value is estimated.

14. The method defined in claim 13 wherein the estimation model is based on at least one of a linear function and an exponential function.

15. An iterative boundary value correction method comprising:
a) deriving an iterative equation that gives a calculated correction to a boundary value component in a pressure control system based on an error between commanded pressure and observed pressure;
b) observing an error between the commanded pressure and the observed pressure that is attributable to boundary value error;
c) calculating a value of the error between the commanded pressure and the observed pressure; and
d) applying a correction in the amount of a fraction of the calculated error to the boundary value component of the pressure control system.

16. The method defined in claim 15 wherein the boundary value component is calculated based on a single determination of the error between the commanded pressure and the observed pressure.

17. The method defined in claim 15 wherein the boundary value correction method is implemented each time a brake system using the boundary value correction method is operated.

18. The method defined in claim 15 wherein the error between the commanded pressure and the observed pressure is determined for an entire operating range of pressures of the pressure control system.

19. The method defined in claim 18 wherein the boundary value errors for the range of pressures is determined by at least one of a pressure upward sweep and a pressure downward sweep through the range of pressures.

20. The method defined in claim 18 wherein the boundary value errors for the range of pressures is determined by both of a pressure upward sweep and a pressure downward sweep through the range of pressures.

21. The method defined in claim 20 wherein the pressure downward sweep has different rates of pressure decrease at different regions in the range of pressures.
